(19) United States
(12) Patent Application Publication
(10) Pub. No.: US 2003/0027527 A1
(43) Pub. Date: Feb. 6, 2003

(54) Method of high-power switching and switch apparatus for frequency modulation within Loran-C signals

(75) Inventor: Paul R. Johannessen, Lexington, MA (US)

Correspondence Address: RINES AND RINES, 81 North State Street, Concord, NH, 03301, US

(73) Assignee: Megapulse, Inc.

(21) Appl. No.: 09/922,283

(22) Filed: Aug. 3, 2001

(51) Int. Cl. H04B 1/00

(52) U.S. Cl. 455/42; 455/112; 455/113

(57) ABSTRACT

Frequency modulation switching apparatus for rapidly increasing and decreasing the frequency within radio-frequency pulses of radio wave pulse trains transmitted by an antenna having series inductance and capacitance, the apparatus having, in combination, a solid state four-terminal rectifier bridge circuit with opposing pairs of bridge terminals connected with one pair of opposing terminals shunting said inductance and said capacitance; and series-connected staturable and linear inductors and an SCR switch connected between the other pair of opposing terminals of the bridge circuit, whereby the high-speed triggering of the SCR on effects corresponding high-speed frequency increasing or decreasing of the frequency within the radio-frequency pulse to provide the desired frequency modulation therein

### FIELD

The present invention relates to radio pulse communications systems and the like, being more particularly concerned with digital signals communicated simultaneously with and on radio navigation signal pulses as of the Loran-C type and the like, such signals being carried by preferably frequency modulation of the signal pulses.

### BACKGROUND

Various types of systems have been proposed and used for adding communication capability to radio navigation signals as described, for example, in U.S. Pat. Nos. 4,800,341 and 4,821,038 of common assignee herewith, and publications discussed therein.

A significant improvement in expanding the digital bit rate (at least from 70 bps to over 250 bps) for communication added to Loran-C radio navigation pulse trains and the like also without affecting the navigation capability and integrity thereof is described in my earlier copending patent application Ser. No. 09/833,022, filed Apr. 11, 2000.

In this copending application, the Loran-C signal is frequency-modulated by tuning or sweeping the high-Q Loran-C antenna frequency between predetermined desired frequencies by varying series inductance and series capacitance at the antenna in steps, by means of fast, high-power, solid-state switches.

The present application discloses a novel solid-state switching methodology and apparatus ideally suited for such Loran-C frequency modulation and the like.

### OBJECTS OF INVENTION

The principal object of the present invention, therefore, is to provide a new and improved method of high-power switching for frequency modulating Loran-C signals and the like.

A further object is to provide such that is particularly adapted for expanding the digital bit rate for communication added to such signals.

Other and further objects will be explained hereinafter and are more particularly delineated in the appended claims.

### SUMMARY

In summary, however, the invention embraces frequency modulation switching apparatus for rapidly increasing and decreasing the frequency within radio-frequency pulses of radio wave pulse trains transmitted by an antenna having series inductance and capacitance, the apparatus having, in combination, a solid state four-terminal rectifier bridge circuit with opposing pairs of bridge terminals connected with one pair of opposing terminals shunting said inductance and said capacitance; and series-connected staturable and linear inductors and an SCR switch connected between the other pair of opposing terminals of the bridge circuit, whereby the high-speed triggering of the SCR on effects corresponding high-speed frequency increasing or decreasing of the frequency within the radio-frequency pulse to provide the desired frequency modulation therein

Preferred and best mode configurations and designs are later detailed. The switch turns off at the end of the rf pulse tail when the SCR current drops below the holding current.

### DRAWINGS

The invention will now be described with a reference to the accompanying drawings in which FIG. 1 presents a circuit diagram of a preferred solid state switching apparatus connected across or shunting an inductor which, together with the switch, is connected in series with the antenna terminals to effect the above-described frequency modulation in accordance with the methodology of the invention;

FIG. 2 presents explanatory current waveforms that would be produced in the operation of the switch if series resistance replaced the series-connected saturable and linear inductors of the switch of FIG. 1, as a comparison with the actual voltage and current waveforms of FIG. 3 that are produced by the inductor switching of FIG. 1;

FIG. 4 is a circuit diagram similar to FIG. 1, but with the switch of the invention shown shunting a capacitor, again connected in series with the antenna terminals; and

FIG. 5 presents the voltage and current waveforms produced in the operation of the circuit of FIG. 4.

### PREFERRED EMBODIMENT(S) OF THE INVENTION

Referring to FIG. 1, an inductor L is shown shunting terminals A and B of a solid-state bridge switching circuit having terminals A, B, C, and D and series-connected with the inductor L with the antenna terminals A′ and B′. Thus, when the switch is closed the inductor L is shorted and the antenna current frequency is increased by

$$Δ f = \frac{1}{2} \frac{L}{{L}_{A}} {f}_{A}$$

where L_{A}=the total antenna series inductance, and f_{A}=the nominal antenna current frequency.

The antenna current of the Loran-C radio pulses i_{A}, generates a voltage across the pair of opposing terminals A and B of the symmetrical-arm bridge switch. This full wave diode bridge (diode arms D1, D2, D3 and D4) rectifies the AC voltage (radio frequency ω) across the inductor L. This rectified voltage appears across the other pair of opposing terminals C and D of the bridge. Between terminals C and D are shown connected in series, a saturable inductor, Lₛ₁, a linear inductor, L_{S2}, and a high-speed triggerable thyristor, SCR. When the SCR is non-conducting, no current can flow in the switch, making

i_{S}=i_{D1}=i_{D2}=i_{D3}=i_{D4}=0

Thus the switch is open.

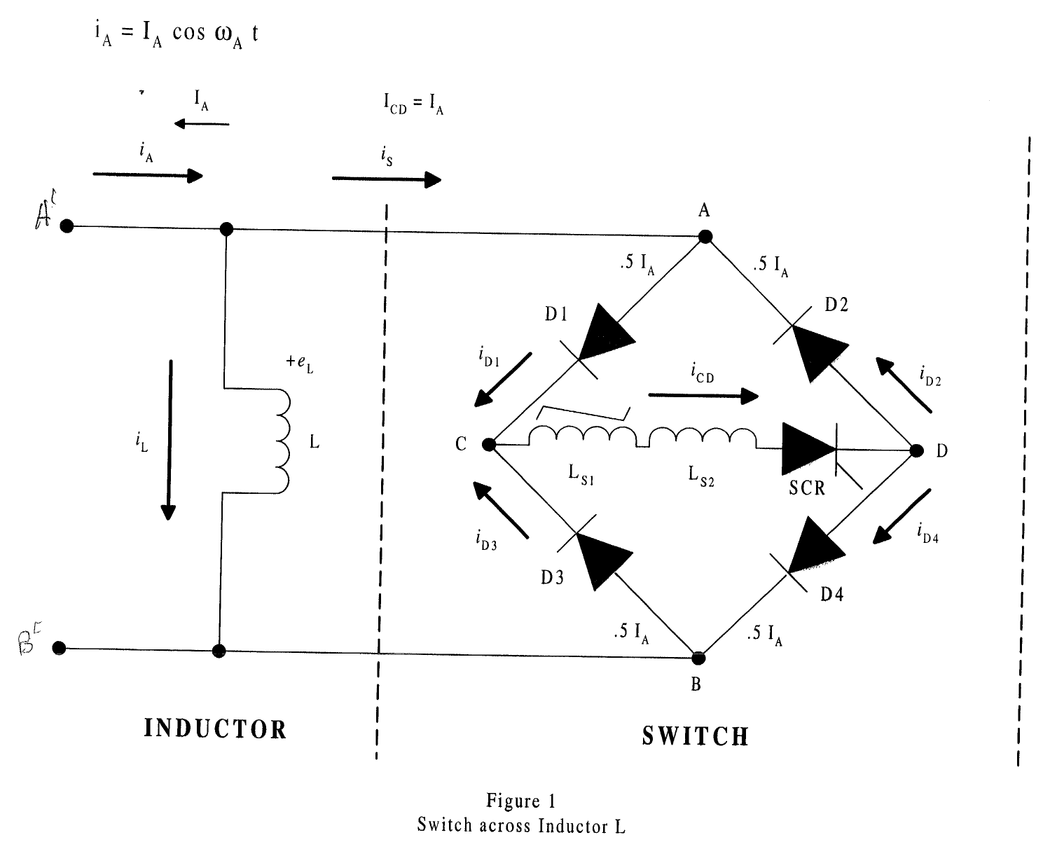

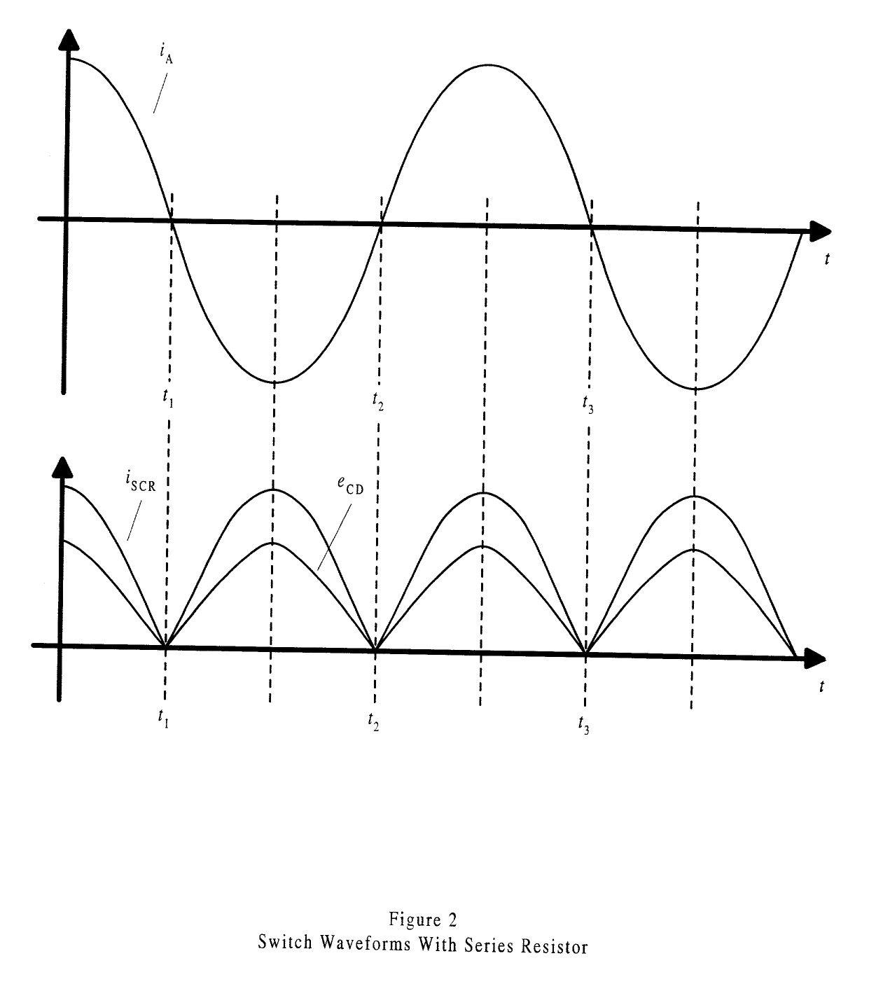

When, however, the SCR is turned on, the fall-wave rectified inductor L voltage appears across inductors L_{S1}, and L_{S2}. If L_{S1} and L_{S2} were two resistors instead of inductors, the voltage and current waveforms would be as shown in FIG. 2; i_{A} representing the antenna current, i_{sCr} the current through the SCR₁, and e_{CD}, the voltage between bridge terminals C and D. To obtain the required switching operation, however, the resistance value of such resistors would have to be very low, resulting in very high di_{scR}/dt-well above the SCR rating. This turn-on problem of the SCR is discussed in U.S. Pat. No. 4,230,955 entitled: “Method and Apparatus For Eliminating Priming and Carrier Sweep-out Losses in SCR Switching Circuits and the Like”.

With the use of the saturable and linear inductors instead of resistors, however, saturable inductor L_{S1} effectively delays the inrush of the SCR current until most of the junction area thereof is turned on. Such use of a saturable inductor as a time-delaying switching means has been extensively used in the past to increase the di/dt rating of an SCR-this technique being referred to as “priming”, as discovered in the above referenced patent. Even with such an increase in the di/dt capability, it is far less than is required in the apparatus of the present application. By connecting another linear inductor, L_{S2}, in series with L_{S1}, however, di/dt can be decreased to an acceptable value.

As an example, if (L_{S1})ₛₐₜ+L_{S2} is made equal to L, the voltage and current waveforms shown in FIG. 3 are obtained when the SCR is turned on at a time 0 and peak antenna current, I_{A}. The antenna current is then split into two components-the current through L and the current through the SCR, i_{CD.} In the interval from 0 to t=π/ω, e_{L} is negative causing diodes D₂ and D₃ to conduct. Since the inductance (L_{S1}) sat+L_{S2} is made equal to L, the voltage across L decreases by a factor of two. At time zero, the inductor current is equal to the antenna current I_{A}. During the time interval from 0 to π/ω), the inductor current decreases to zero, and the SCR current, i_{CD}, increases from zero to I_{A}, as shown in FIG. 3. At time t=π/2, the inductor voltage goes from a negative to a positive value, causing diode D1 and D4 to conduct. At this time, the antenna current starts to decrease in magnitude while the SCR current remains constant. All diodes conduct so long as i_{A}<i_{CD} and the voltage across the bridge is very small, equal to the voltage drop of the conducting diodes. Thus, the inductor current remains constant at a very low value, and the desired switching operation has taken place in less than half-a-cycle of the antenna current. The maximum di/dt of the SCR is

$${( \frac{ⅆ {i}_{SCR}}{ⅆ t} )}_{max} = \frac{1}{2} {I}_{A} ω \text{(amps/sec)}$$

It should be noted from the waveforns, also, that no harmonics have been generated during this switching tuning process of the invention, that provides the required tuning increase in frequency of the desired frequency modulation.

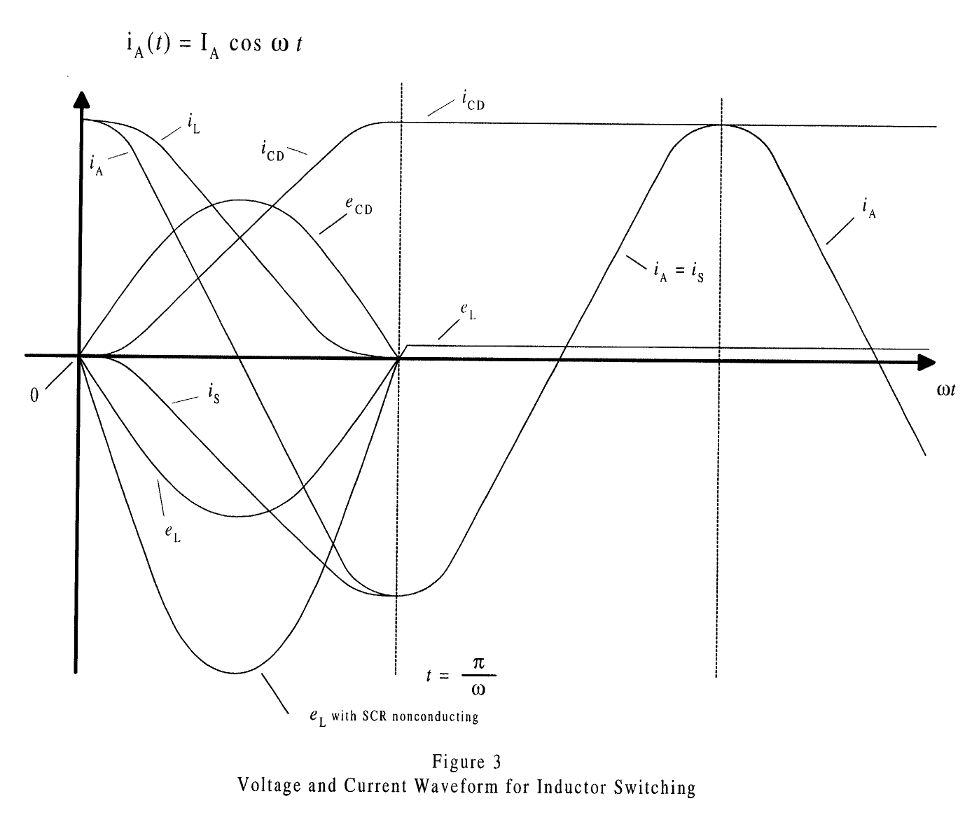

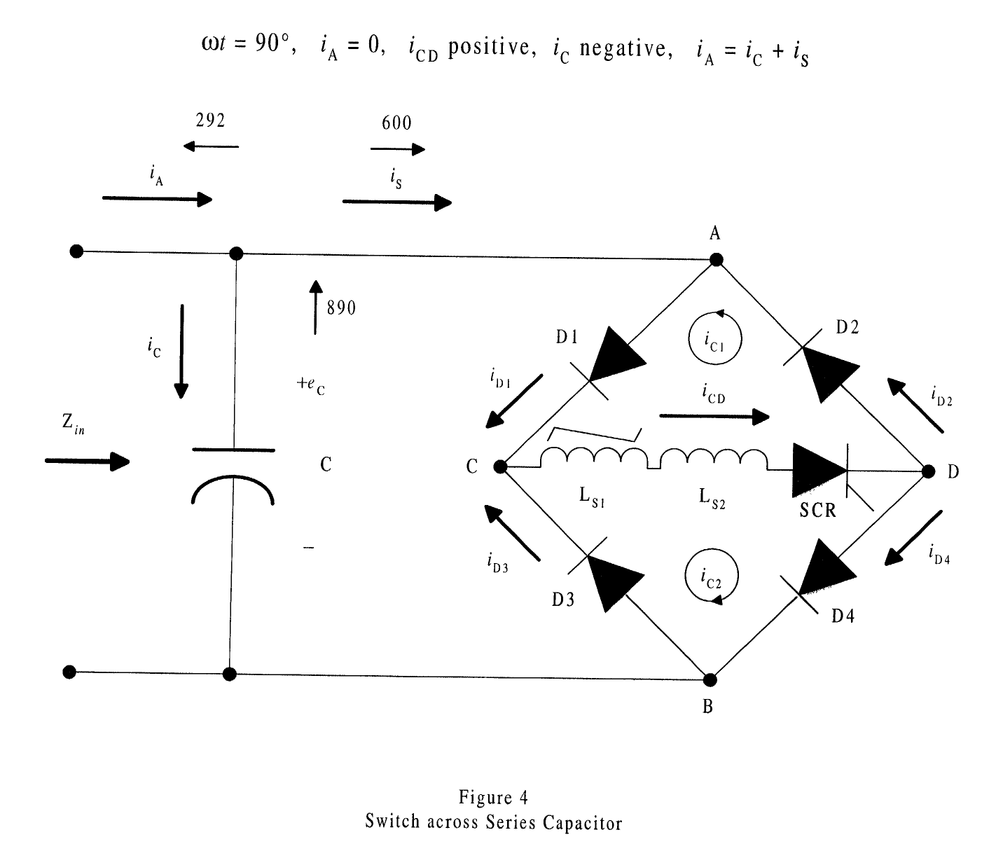

To decrease the frequency tuning for the frequency modulation of the invention, the antenna series capacitance is increase by shorting out one of the antenna series capacitors C, FIG. 4. The switch is also connected across this series capacitor C, and when the switch is closed at peak antenna current, the voltage and current waveforms are obtained as follows:

i_{A}(t)=I_{A}cosωt

$${I}_{A} ( s ) = {I}_{A} \frac{s}{{s}^{2} + {ω}^{2}}$$

$$\begin{matrix}{E}_{C} ( s ) = {I}_{A} ( s ) \times {Z}_{in} ( s ) \\ = {I}_{A} \frac{s}{{s}^{2} + {ω}^{2}} \times \frac{1}{C} \frac{s}{{s}^{2} + \frac{1}{LC}}\end{matrix}$$

where

L=L_{S1}+L_{S2}

By making

$$\frac{1}{LC} = {ω}^{2}$$

$$\text{results in} {E}_{C} ( s ) = \frac{1}{C} {I}_{A} \frac{{s}^{2}}{{( {s}^{2} + {ω}^{2} )}^{2}}$$

$$\text{and} \frac{1}{2 ω C} , \\ \begin{matrix}{e}_{c} ( t ) = \frac{1}{C ( 2 ω )} {I}_{A} ( sin ω t + ω t cos ω t ) \\ {i}_{c} ( t ) = C \frac{ⅆ}{ⅆ t} {e}_{c} ( t ) = \frac{1}{2} {I}_{A} ( 2 cos ω t - ω t sin ω t )\end{matrix}$$

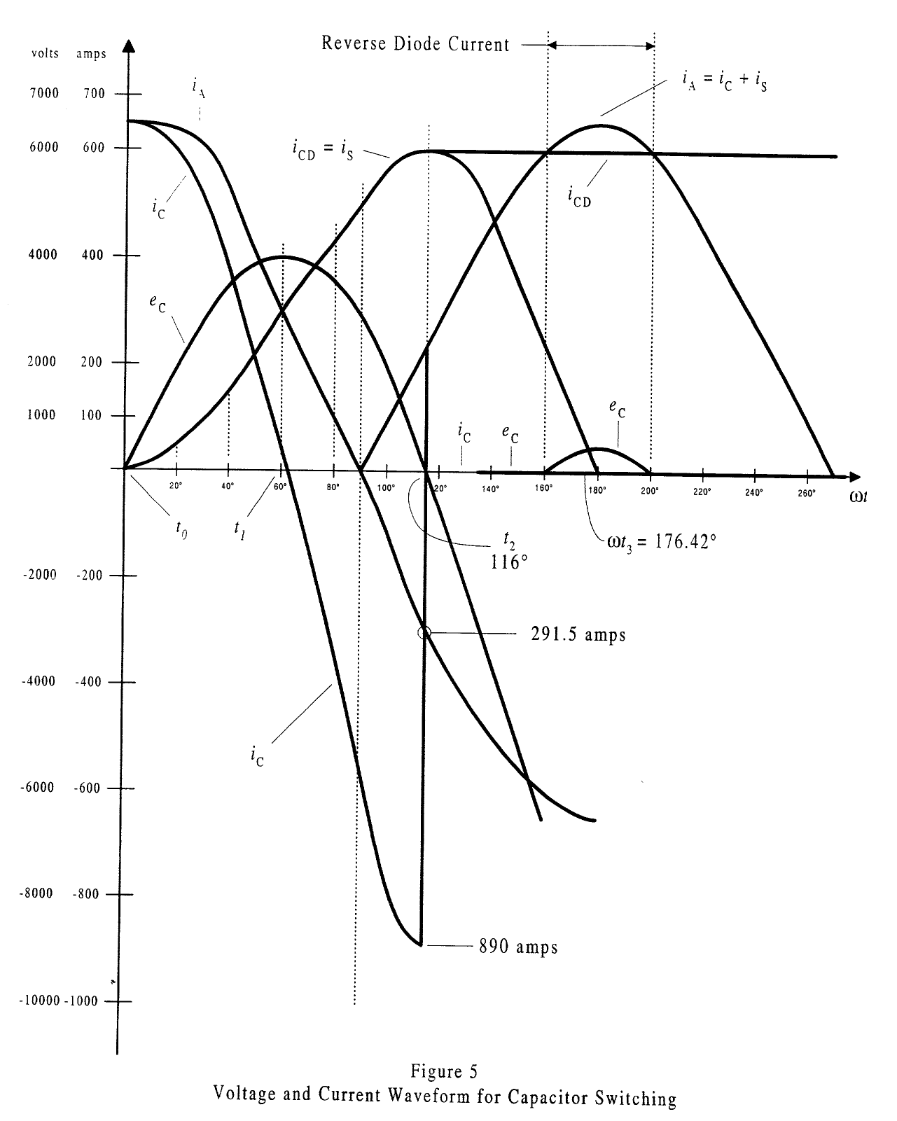

The voltages and currents plotted in FIG. 5 are obtained, when the SCR is turned on at time zero, the currents i_{A} and i_{c} are equal such that

i_{c}(o)=i_{A}(o)=I_{A}

The initial current in the diode bridge, i_{cd}(0), and the initial voltage on the capacitor C are both zero. Following the SCR turn-on, the voltage e_{c}(t) rises sinusoidally to a peak value at time

$${t}_{1} = \frac{60}{ω}$$

$$\text{and then returns to zero at time}$$

$${t}_{2} \approx \frac{116}{ω}$$

This positive voltage wave generates the diode bridge current

$${i}_{CD} ( t ) = \frac{1}{2} {I}_{A} ω t sin ω t$$

$$\text{At time}$$

$${t}_{2} = \frac{116}{ω}$$

the diode bridge current reaches a maximum of

i_{CD}(t₂)≈0.9I_{A}

For t>t₂

i_{c}(t)≈o

e_{c}(t)≈o

i_{CD}(t)≈0.9I_{A}

The diode bridge conducts until the antenna current i_{A} (t) exceeds the diode bridge current i_{CD}(t). This event occurs at time

$${t}_{3} = \frac{176}{ω} .$$

At this time, the diode currents

i_{D1}(t₃)=i_{D4}(t₃)=o

i_{D2}(t₃)=t_{D3}(t₃)=0.9I_{A}

Thus, for t>t₃, the diodes D1 and D4 stop conducting and a voltage is generated across L_{S1} and L_{S2}.

However, the diodes selected for the bridge in accordance with the invention are slow, general purpose rectifiers. The minority carrier recombination time is long compared to 5 μsec, so that almost all minority carriers in the diode junction must be swept out by the reverse diode current. Thus, the SCR current can be considerably less than the peak antenna current and still the switch performs the desired switching operation for the phases of the invention. The switching time is less than half-a-cycle of the antenna current. The maximum di/dt of the SCR is then

$${( \frac{ⅆ {i}_{SCR}}{ⅆ t} )}_{max} = .32 {I}_{A} ω \text{[amps/sec]}$$

Thus, the technique and circuits of the invention have provided an effective switching of frequency by the above-described varying of the series inductance L and of the series capacitance C at the antenna in steps by the use of fast, high power solid state bridge switching of the invention, achieving the frequency modulation of the Loran-C radio pulses fed to the antenna between desired frequencies.

While described in connection with its important Loran-C application, the invention is also useful for adding communication to other radio-transmitting systems and further modifications will also occur to those skilled in the art, such being considered to fall within the spirit and scope of the invention as defined in the appended claims.

What is claimed is:

1. Frequency modulation switching apparatus for rapidly increasing and decreasing the frequency within radio-frequency pulses of radio wave pulse trains transmitted by an antenna having series inductance and capacitance, the apparatus having, in combination, a solid state four-terminal rectifier bridge circuit with opposing pairs of bridge terminals connected with one pair of opposing terminals shunting said inductance and said capacitance; and series-connected staturable and linear inductors and an SCR switch connected between the other pair of opposing terminals of the bridge circuit, whereby the high-speed triggering of the SCR on effects corresponding high-speed frequency increasing or decreasing of the frequency within the radio-frequency pulse to provide the desired frequency modulation therein.

2. The apparatus of claim 1 wherein the radio-wave pulse trains are Loran-C navigation pulses.

3. The apparatus of claim 2 wherein the bridge rectifiers are symmetrically disposed in each of the arms of the bridge.

4. The apparatus of claim 2 wherein the triggering of the SCR is effected in accordance with digital bits comprising communication to be added to the Loran-C navigation transmissions and without impacting the navigation utilization thereof.
